(19) United States
(12) Patent Application Publication
(10) Pub. No.: US 2021/0255584 A1
(43) Pub. Date: Aug. 19, 2021

(54) METHOD AND APPARATUS FOR GENERATING FULL-COLOR HOLOGRAPHIC IMAGE

(71) Applicant: ELECTRONICS AND TELECOMMUNICATIONS RESEARCH INSTITUTE, Daejeon (KR)

(72) Inventor: Ki Hong CHOI, Daejeon (KR)

(21) Appl. No.: 17/166,424

(22) Filed: Feb. 3, 2021

(30) Foreign Application Priority Data
Feb. 18, 2020 (KR) 10-2020-0019498
Nov. 23, 2020 (KR) 10-2020-0157616

(51) Int. Cl. G03H 1/26; H04N 9/04

(52) U.S. Cl. CPC G03H 1/2645; H04N 9/04557; H04N 9/04517; G03H 2223/23; G03H 2001/266; G03H 2001/267; G03H 2226/11; G03H 2240/13

(57) ABSTRACT

The present disclosure provides a method and apparatus for generating a full-color holographic image. The method of generating a full-color holographic image includes forming images for each color channel based on complex hologram data extracted from rays propagating from a target object, and combining the formed images into one color image, wherein the images for each color channel are formed at reconstruction points for each color channel derived based on the complex hologram data.

### CROSS REFERENCE TO RELATED APPLICATIONS

The present application claims priority to Korean Provisional Application No. 10-2020-0019498, filed Feb. 18, 2020 and Korean Provisional Application No. 10-2020-0157616, filed Nov. 23, 2020, the entire contents of which are incorporated herein for all purposes by this reference.

### BACKGROUND OF THE INVENTION

### 1. Field of the Invention

The present disclosure relates to a method and apparatus for generating a full-color holographic image, and more particularly, to technology for reproducing a holographic image, from which chromatic aberration has been removed using a holographic optical system.

### 2. Description of Related Art

In recent years, as interest in realistic media such as virtual reality and augmented reality is increasing in various industries including movies, broadcasting, entertainment, aerospace, military, medical treatment, etc., researches into three-dimensional (3D) stereoscopic image display technology is being conducted.

In order to provide the same effect as an object being actually located in front of human eyes, holography technology for recording and reproducing wavefront information of a three-dimensional (3D) object has been devised. Holography technology is characterized in that amplitude and phase information of light propagating from an object is acquired and recorded unlike general photography technology. Until now, since there is no sensor capable of directly recording the amplitude and phase information of visible light, when the amplitude and phase information of visible light is acquired, related information is indirectly acquired through light interference to generate a hologram. Interference refers to a phenomenon occurring by interaction between two light waves of object light reflected from the surface of the object and reference light diffused to a lens. Since it is difficult to acquire interference fringes without using a laser whose amplitude and phase are artificially aligned, lasers have been mainly used in holography technology up to recently.

However, in the case of using such a laser, since all light other than the laser needs to be blocked, there is a problem that a hologram cannot be substantially photographed and recorded in an external environment.

### SUMMARY

The present disclosure provides a method and apparatus for generating full-color holographic image.

According to the present disclosure, a method of generating a full-color holographic image, the method may comprise forming images for each color channel based on complex hologram data extracted from rays propagating from a target object; and combining the formed images into one color image, wherein the images for each color channel are formed at reconstruction points for each color channel derived based on the complex hologram data.

According to the present disclosure, an apparatus for generating a full-color holographic image, the apparatus may comprise a transceiver configured to transmit and receive a signal; and a processor configured to control the transceiver, wherein the processor forms images for each color channel based on complex hologram data extracted from rays propagating from a target object and combines the formed images into one color image, and wherein the images for each color channel are formed at reconstruction points for each color channel derived based on the complex hologram data.

According to the present disclosure, a system for generating a full-color holographic image, the system may comprise polarizers configured to define rays propagating from a target object in a linear polarized state; a diffractive lens configured to modulate the rays defined in the linear polarized state from the polarizer to have positive or negative curvature; a color polarization image sensor configured to record an interference fringe through the polarizers rotated to have different phases based on the modulated rays; and a full-color holographic image generation apparatus configured to generate a full-color hologram by combining images for each color channel formed based on complex hologram data acquired based on the interference fringe.

According to the present disclosure, it is possible to obtain a full-color hologram in which the color dispersion effect of the lens is removed.

According to the present disclosure, it is possible to provide a lens optical system having significantly reduced thickness and weight compared to a conventional lens optical system.

According to the present disclosure, it is possible to provide a next-generation lens element including a meta lens and a geometric phase lens.

The effects obtainable in the embodiments of the present disclosure are not limited to the above-mentioned effects, and other effects not mentioned may be clearly derived and understood by those ordinary skilled in the art to which the technical configuration of the present disclosure is applied from the following description of the embodiments of the present disclosure.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a diffractive thin-film lens applicable to the present disclosure;

FIG. 2 is a view illustrating a meta lens or a geometric phase lens applicable to the present disclosure;

FIG. 3 is a view illustrating a self-interference holography system, to which a diffractive thin-film lens is applied according to an embodiment of the present disclosure;

FIG. 4 is a view illustrating the structure of a monochromatic polarization image sensor according to an embodiment of the present disclosure;

FIG. 5 is a view illustrating a pixel array of a color polarization image sensor according to an embodiment of the present disclosure;

FIG. 6 is a view illustrating a ray processing procedure of a general image generation system using a diffractive thin-film lens according to an embodiment of the present disclosure;

FIG. 7 is a view illustrating a ray processing procedure of a holographic image generation system using a diffractive thin-film lens according to an embodiment of the present disclosure;

FIG. 8 is a view illustrating a full-color holographic image generation system using a diffractive thin-film lens according to an embodiment of the present disclosure;

FIG. 9 is a view illustrating a process of acquiring a complex hologram in a color polarization image sensor according to an embodiment of the present disclosure;

FIG. 10 is a view illustrating a full-color holographic image generation method according to an embodiment of the present disclosure; and

FIG. 11 is a view illustrating a full-color holographic image generation apparatus according to an embodiment of the present disclosure.

### DETAILED DESCRIPTION OF THE INVENTION

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. In addition, parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, embodiments that include other components in addition to the components described in the various embodiments are also included in the scope of the present disclosure.

Hereinafter, embodiments of the present disclosure will be described with reference to the accompanying drawings.

In the present disclosure, a diffractive thin-film lens may be used interchangeably with a diffractive lens.

In the present disclosure, holographic image generation technology may be used interchangeably with hologram image reproduction technology.

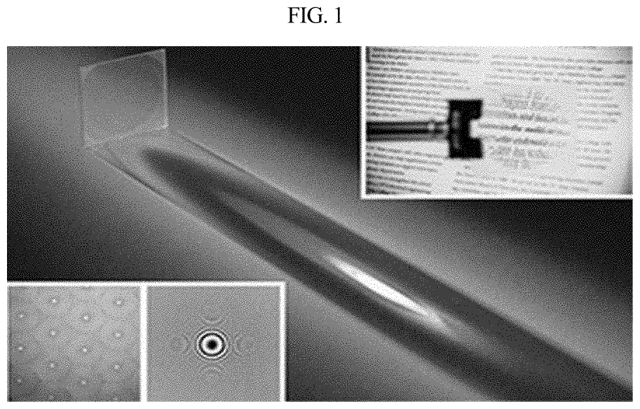

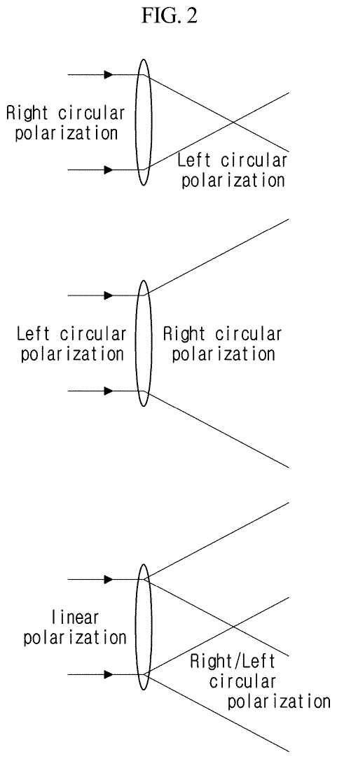

FIG. 1 is a view illustrating a diffractive thin-film lens applicable to the present disclosure, and FIG. 2 is a view illustrating a meta lens or a geometric phase lens applicable to the present disclosure. More specifically, these are views illustrating the effect of chromatic dispersion according to the optical characteristics of a diffractive thin-film lens.

In general, a lens adjusts the thickness of a medium to make a difference in refractive index and modulates an incident wavefront to converge or diverge rays. Although chromatic aberration according to the effect of chromatic dispersion appears even in a general lens due to a change in refractive index according to the wavelength of rays, the degree of chromatic aberration is not very severe and chromatic aberration may be alleviated by aspherical design, a doublet lens, etc.

Meanwhile, a representative diffractive thin-film lens such as a meta lens or a geometric phase lens is characterized in that the phase of the wavefront is modulated by differentiating a two-dimensional orientation angle of liquid crystal or a nano-scale metal rod according to the space. The diffractive thin-film lens may perform the same function as a convex or concave lens according to the circularly polarized state of incident light, and has optical characteristics that half of light converges and the other half of light diverges when linear polarized light is input.

In this case, in a thin-film lens using a diffraction effects, such as a meta lens or a geometric phase lens, since the period of a diffraction grating has a fixed value for a specific wavelength, when light having other wavelengths are input, a chromatic aberration phenomenon that a focal length varies according to the wavelength occurs similarly to a general lens. In this case, since the chromatic aberration effect may be greater than when using the general lens, when such a diffractive thin-film lens is used to generate an image, an imaging position according to three primary colors is changed and thus magnification may also be changed. When the imaging position according to three primary colors is changed and thus magnification is also changed, there may be a problem that the quality of a hologram image deteriorates.

In order to solve such a problem, in the present disclosure, holographic image generation (holographic imaging) technology for reproducing a hologram image from which the chromatic aberration effect is removed while using a diffractive thin-film lens is proposed. Hereinafter, the embodiments of the present disclosure will be described in detail with reference to the accompanying drawings.

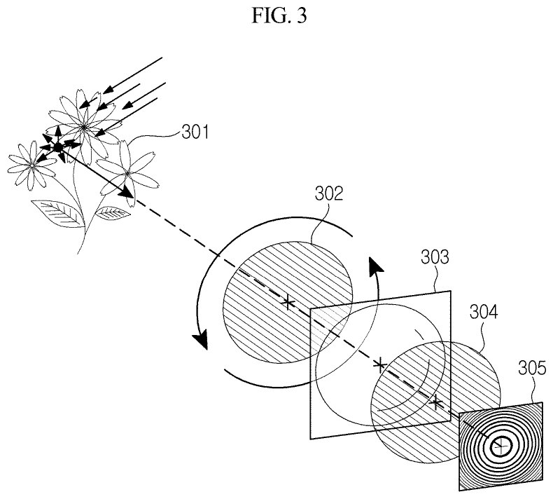

FIG. 3 is a view illustrating a self-interference holography image generation system, to which a diffractive thin-film lens according to an embodiment of the present disclosure is applied. More specifically, FIG. 3 is a view illustrating the structure and operation of a self-interference digital holography image generation system using a diffractive thin-film lens for a holographic image as a wavefront modulator.

As an embodiment, the self-interference digital holography image generation system may include an object 301 to be photographed, a rotary polarizer 302, a diffractive thin-film lens 303, a fixed polarizer 304 and an image sensor 305.

When object light reflected from the object 301 to be photographed and reference light are incident on the rotary polarizer 302, a geometric phase change may be given to rays through the rotary polarizer. Accordingly, wavefront separation/modulation and phase shift may be implemented by only a geometric phase change, not phase delay.

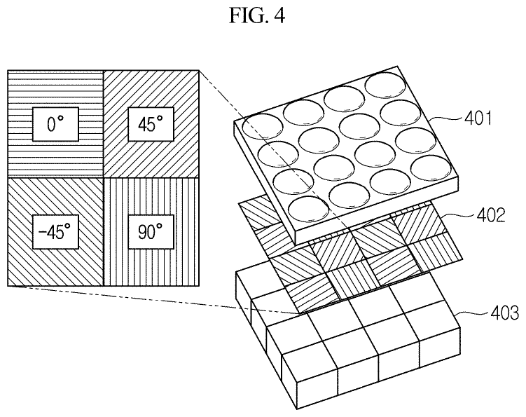

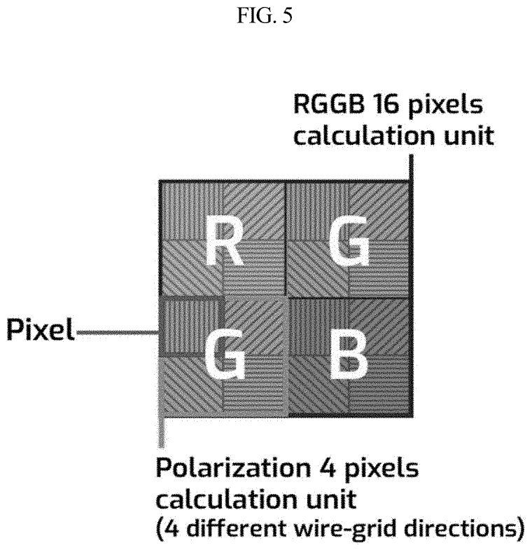

Meanwhile, as an embodiment, the rotary polarizer 302 and/or the fixed polarizer 304 may have a 2×2 unit configuration for the pixel of an image sensor. In addition, as an embodiment, the fixed polarizer 304 and the image sensor 305 may be implemented by one polarization image sensor, which will be described in greater detail with reference to FIGS. 4 and 5.

As an embodiment, according to a self-interference holographic image generation system, an interference fringe may be acquired by a self-reference method of splitting incident light emitted and reflected from an object according to the spatial or polarized state, and a holographic image may be generated based on the acquired interference fringe. The split light waves may be modulated into wavefronts having different curvatures and propagated by influence of an interferometer or a polarization modulator, forming an interference fringe on the image sensor. In this case, since interference occurs between twin light waves originating from light in the same space and time, the condition of a light source may be free. Accordingly, photographing is possible under fluorescent, light bulb, LED or natural light conditions.

In addition, according to the self-interference holography system, when interference occurs between two light waves having the same traveling direction, a complex hologram, information on a light source, and information on a twin image of a hologram may be acquired. As an embodiment, this may be expressed by Equation 1 below.

|ψ₁+ψ₂|²=|ψ₁|²+|ψ₂|²ψ₁ψ₂*+ψ₁*ψ₂ <Equation 1>

In Equation 1, ψ₁ and ψ₂ are two light waves having the same traveling direction, ψ₁ψ₂* is a complex hologram, |ψ₁|²+|ψ₂|² is information on a light source, and ψ₁*ψ₂ is a twin image of a hologram.

Meanwhile, in order to utilize all the resolution of the image sensor of the holography system, the traveling directions of the two interfering light waves ψ₁ and ψ₂ need to be the same, such that the information on the light source and the twin image are recorded to overlap the complex hologram to be acquired as shown in Equation 1. The information on the light source |ψ₁|²+|ψ₂|²and the information on the twin image ψ₁*ψ₂ act like noise when reproducing a holographic image, that is, a hologram, thereby deteriorating the quality of the image. Therefore, there is a need for technology for removing the information.

As an embodiment, in order to extract only information necessary for Equation 1, that is, the complex hologram ψ₁ψ₂ *, phase shift holography image generation technology may be used. The phase shift holography image generation technique is characterized in that a relative phase difference between two interfering light waves is differently given and then the light waves are combined. As an embodiment, in order to give a phase difference to two interfering light waves, a method of adjusting a difference in optical path, giving phase delay or adjusting a geometric phase through rotation of a polarizer as described above may be used.

Meanwhile, as an embodiment, Equation 2 below is an equation for a representative four-step phase shift holography technique. According to the four-step phase shift holography technique, a relative phase difference between two light waves may be 0 degrees, 90 degrees, 180 degrees and 270 degrees.

ψ₁ψ₂*=c₀[(I_{180°}−I_{0°})−j(I_{270°}−I_{180°})] <Equation 2>

As an embodiment, ψ₁ψ₂* of Equation 2 above may mean a complex hologram similarly to Equation 1 above, c₀ may be a real number, and I_{δ} may mean an interference fringe having a phase difference of δ.

As an embodiment, an interference fringe for each polarization and color may be generated based on complex hologram data acquired through Equations 1 and 2 above, and a holographic image may be generated based on the generated interference fringe, which will be described in greater detail below with reference to the other drawings.

Meanwhile, Equation 1, Equation 2 and the steps of the phase shift holography technique are only an embodiment of the present disclosure and the present disclosure is not limited thereto.

FIG. 4 is a view illustrating the pixel structure of a monochromatic polarization image sensor according to an embodiment of the present disclosure. More specifically, FIG. 4 is a view showing the pixel structure of an image sensor having a structure in which photodiodes 403 attached with a microlens array 401 and a polarizer array 402 in order to acquire polarization information of a target object are two-dimensionally arranged.

As an embodiment, the microlens array 401 may be attached on the polarizer array 402. For example, the polarizer array may be configured to have a 2×2 configuration for a pixel, and each polarizer may rotate by 0 degrees, 45 degrees, −45 degrees and 90 degrees, in order to adjust the geometric phase of the light wave as described above. Meanwhile, the degree of rotation of each polarizer is only an embodiment and the present disclosure is not limited to the above example.

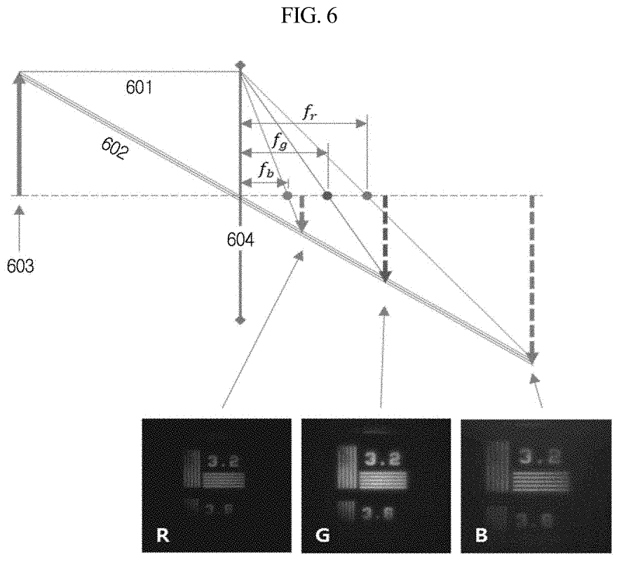

As another embodiment, the polarization image sensor shown in FIG. 4 may be included in a holographic image generation system or apparatus. The holographic image generation system and apparatus according to an embodiment of the present disclosure will be described in greater detail below with reference to FIGS. 6 to 11.

Meanwhile, the image sensor of FIG. 4 is a monochromatic polarization image sensor. A color polarization image sensor may obtained by additionally attaching a color filter to the image sensor of FIG. 4. The color polarization image sensor will be described in greater detail below with reference to FIG. 5.

FIG. 5 is a view illustrating a pixel array of a color polarization image sensor according to an embodiment of the present disclosure. More specifically, FIG. 5 is a view illustrating a pixel array of a color polarization image sensor attached with a color filter in addition to a polarizer array.

As an embodiment, in the case of a color polarization image sensor, four polarization components may be expressed by three color channels (e.g., R, G and B), by photographing a target object once (e.g., R, G, G and B). In this case, each color channel may be composed of, for example, four pixels and pixels may be based on different wire-grid directions. As an embodiment, a total of four polarization components may be expressed by RGGB and may be composed of sixteen pixels.

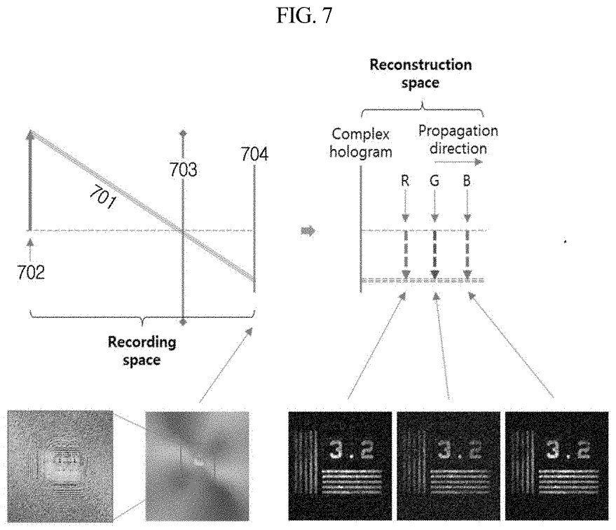

FIG. 6 is a view illustrating a ray processing procedure of a general image generation system using a diffractive thin-film lens according to an embodiment of the present disclosure, and FIG. 7 is a view illustrating a ray processing procedure of a holographic image generation (holographic imaging) system using a diffractive thin-film lens according to an embodiment of the present disclosure.

As an embodiment, the general image generation system of FIG. 6 may include a target object 603, an incident chief ray 602, a marginal ray 601 and a diffractive lens 604.

As an embodiment, it is assumed that object light from the target object 603 is incident on the diffractive lens 604. At this time, the chief ray 602 and the marginal ray 601 are generated and are incident on the diffractive lens 604, thereby causing chromatic dispersion.

As described above, the diffractive thin-film lens 604 such as the meta lens or the geometric phase lens shown in FIG. 6 has diffraction characteristics having wavelength dependency, such that the colors (e.g., R, G and B) may not be formed on the same imaging plane for each color channel in a full-color holographic image generation process (fᵣ≠f_{g}≠f_{b}), that is, chromatic aberration is caused. Chromatic aberration may cause deterioration of overall image quality. Therefore, in order to cancel chromatic aberration, it is possible to implement the holographic image generation system of FIG. 7.

As an embodiment, the holographic image generation system of FIG. 7 may include a target object 702, a chief ray 701, a diffractive lens 703, and an image sensor 704. The space before the image sensor may be a hologram recording space and, after the image sensor, a reconstruction space may be configured based on a complex hologram.

Even when the holographic image generation system of FIG. 7 is used, a marginal ray is generated in the light wave which has passed through the diffractive thin-film lens. The degree of divergence or convergence of the marginal ray may vary according to the wavelength of the ray. However, since the chief ray certainly passes through the center of the lens, the chief rays of all wavelengths may pass the same path even after passing through the lens. In this case, when the image sensor is disposed after the lens such that the ray which has passed through the lens reaches the image sensor, all the chief rays of respective wavelengths may reach the same position of the image sensor.

As an embodiment, when the chief rays of respective wavelengths which has reached the same position are recorded as a hologram based on Fresnel diffraction, interference fringes may be recorded as Fresnel fringes and may all be formed at the same point. When this is reconstructed numerically, since images with the same magnification may be acquired for all colors, it is possible to acquire a full-color holographic image from which chromatic aberration is removed.

Meanwhile, as an embodiment, the image sensor of the holographic image generation system of FIG. 7 may be the color polarization image sensor of FIG. 5.

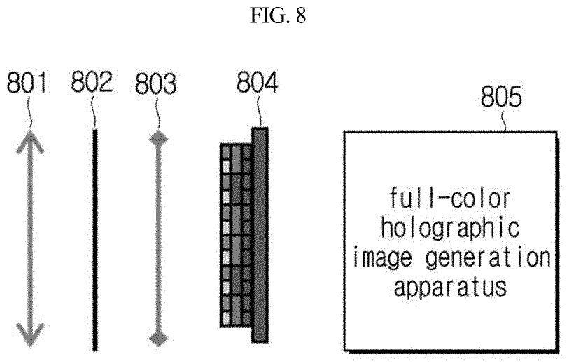

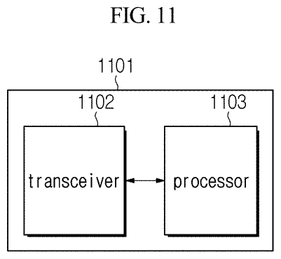

Meanwhile, as an embodiment, the holographic image generation system for performing the ray processing procedure of FIG. 7 may be a full-color holographic image generation system using a diffractive thin-film lens of FIG. 8 or 11.

In addition, as an embodiment, although not shown in FIGS. 6 and 7, the full-color holographic image generation apparatus may be included in the full-color holographic image generation system, and may correspond to the full-color holographic image generation apparatus of FIG. 8 or 11.

FIG. 8 is a view illustrating a full-color holographic image generation system using a diffractive thin-film lens according to an embodiment of the present disclosure.

As an embodiment, the full-color holographic image generation system may include a target object, an objective lens 801, a polarizer 802, a diffractive lens 803 and a color polarization image sensor 804 and a full-color holographic image generation apparatus 805. In this case, the diffractive lens may be a diffractive thin-film lens and includes a meta lens or a geometric phase lens.

Meanwhile, FIG. 8 shows an embodiment of the present disclosure, in which the shapes or configurations of the lenses, the polarizer, the full-color polarization image sensor and the full-color holographic image generation apparatus are arbitrarily separated in order to describe the functions thereof in detail and clearly. Accordingly, several elements shown in FIG. 8 may be included in one full-color holographic image generation apparatus, and all functions performed by the full-color holographic image generation apparatus may be performed by the full-color polarization image sensor. That is, it may be implemented by one or more hardware or software components in various ways.

Meanwhile, the color polarization image sensor 804 may be a polarization image sensor attached with a color filter, described with reference to FIG. 5. In addition, the structure of the polarization image sensor excluding the color filter may include the structure of the image sensor described in FIG. 4.

As another embodiment, a spherical wave originating from a place where a target object is located after the object is photographed, that is, an object point, may be input to the system through the objective lens 801 and may be defined as a linear polarized state by the polarizer 802. Modulation may be performed such that half of the polarized light input through the diffractive lens 803 has positive curvature and the other half has negative curvature. Thereafter, when passing through the polarizer of the color polarization image sensor 804, brightness information according to interference may be recorded on a sensor surface as an original image.

As an embodiment, the color polarization image sensor 804 may include polarizer which may be configured to have a 2×2 configuration for a pixel as described with reference to FIG. 5. The polarizer may rotate by 0 degrees, 45 degrees, 90 degrees and 135 degrees for each pixel. According to the relative angle of the polarizer, interference fringes having different phases are recorded in an original image with different brightness values. Meanwhile, since the different set angle values of the polarizers are only an embodiment, angle values different from the above-described angles may be used.

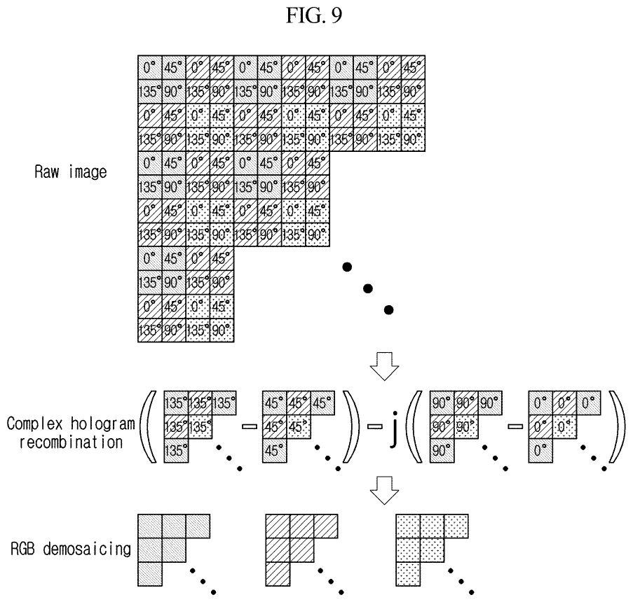

Thereafter, an interference fringe for each polarization and color channel may be extracted from the original image by the color polarization image sensor 804. In this case, the original image may be, for example, a raw image and may be one of a bmp or png image. In addition, as an embodiment, at least one interference fringe for each polarization and color may be extracted, and, for example, 12 interference fringes may be extracted. As an embodiment, the interference fringes may be extracted based on a holography image generation technique including the above-described self-interference holography image generation technique. As an embodiment, the color polarization image sensor 804 may derive complex hologram data by removing information related to the light source and twin image information for each color channel (e.g., R, G and B) based on the extracted interference fringes for each polarization and color. This may be based on Equations 1 and 2 above. Meanwhile, since Equation 2 is created based on a four-step phase shift technique as an example, complex hologram data may be derived by another equation created based on an arbitrary n-step phase shift technique. A process of acquiring complex hologram data from an original image in a color polarization image sensor will be described in greater detail with reference to FIG. 9.

The full-color holographic image generation apparatus 805 may reconstruct a full-color holographic image based on the complex hologram data acquired from the color polarization image sensor. For example, images may be formed at optimal reconstruction points for each color channel using an angular spectrum method or a Fresnel diffraction method. As an embodiment, when an imaging distance z₁ for the center wavelength λ₁ of one color channel has been acquired or is a known value, an imaging distance z₂ for the center wavelength λ₁ of another color channel may be determined as shown in Equation 4 below.

$${z}_{2} = {z}_{1} \frac{{λ}_{1}}{{λ}_{2}} \qquad < Equation 4 >$$

In this case, the imaging distances z₁ and z₂ and an imaging distance z₃ for another color channel may correspond to optimal reconstruction points for each color channel. When images are formed for each color channel and combined into one color image, a clear full-color image without the chromatic aberration effect may be acquired.

Meanwhile, the embodiment of the full-color holographic image generation apparatus will be described in greater detail with reference to FIG. 11.

FIG. 9 is a view illustrating a process of acquiring a complex hologram in a color polarization image sensor according to an embodiment of the present disclosure.

As an embodiment, the color polarization image sensor of FIG. 9 may be the color polarization image sensor of FIG. 5, the color polarization image sensor obtained by attaching a color filter to the monochromatic polarization image sensor including the polarizer array of FIG. 4, or the image sensor included in the full-color holographic image generation system of FIG. 8.

In addition, as an embodiment, before the process of acquiring the complex hologram of FIG. 9 is performed, the process described in FIG. 8 may be performed. That is, the complex hologram of FIG. 9 may be based on the interference fringes for each polarization and color extracted from the original image.

The original image obtained by photographing the target object may be, for example, a raw image and may be one of a bmp or png image. As an embodiment, the original image may be generated based on brightness information according to interference as described above with reference to FIGS. 5 and 8. The brightness information according to inference may be acquired by the color polarization image sensor. As an embodiment, the color polarization image sensor may express four polarized components (e.g., R, G, G and B) in three colors (e.g., R, G and B). In this case, the polarizers may have different phase values, for example, 0 degrees, 45 degrees, 90 degrees and 135 degrees.

As an embodiment, the color polarization image sensor may acquire brightness information according to interference by classifying the polarized components having the same phase. As an embodiment, complex hologram data ψ₁ψ₂* may be acquired using Equation 3 through the original image (e.g., raw, bmp or png image) acquired based on the brightness information according to interference. For example, Equation 3 may be obtained by changing Equation 2.

ψ₁ψ₂*=c₀[(I_{135°}−I_{45°})−j(I_{90°}−I_{0°})] <Equation 3>

As an embodiment, ψ₁ψ₂* of Equation 3 may means a complex hologram similarly to Equation 2, c₀ may be a real number, and I_{δ} may mean an interference fringe having a phase difference of δ. The complex hologram data acquired based on Equation 3 may be in a state in which the information related to the light source and the twin image information are removed for each color channel. Based on this, components may be collected for each color channel (demosaicing).

Thereafter, according to the full-color holographic image generation apparatus or the full-color holographic image generation system according to the embodiment of the present disclosure, as described above, based on the components collected for each color channel of the color polarization image sensor, images may be formed (for each color channel) according to the optimal reconstruction points for each color channel described in FIG. 8. Thereafter, the images formed for each color channel may be combined into one color image. Accordingly, as a result, it is possible to acquire a clear full-color image without the chromatic aberration effect.

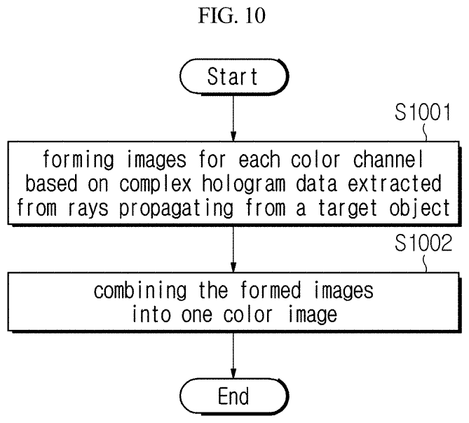

FIG. 10 is a view illustrating a full-color holographic image generation method according to an embodiment of the present disclosure.

As an embodiment, the full-color holographic image generation method of FIG. 10 may be performed by the full-color holographic image generation system of FIGS. 8 to 9 or the full-color holographic image generation apparatus of FIG. 11. Accordingly, the above description is applicable to the full-color holographic image generation method of FIG. 10, unless it is contrary to the description of FIG. 10.

As an embodiment, the full-color holographic image generation system or apparatus may form images for each color channel based on complex hologram data extracted from rays propagating from a target object (S1001). Meanwhile, images may be formed at optimal reconstruction points for each color channel derived based on the complex hologram data.

Meanwhile, the complex hologram data in the imaging step S1001 may be derived based on the interference fringe acquired by the color polarization image sensor. The interference fringe may be recorded based on the rays propagating from the target object, and, for example, the rays propagating from the target object may have passed through the object lens, the polarizer, the diffractive lens and the color polarization image sensor. As an embodiment, the diffractive lens may be one of a meta lens or a geometric phase lens. As an embodiment, a spherical wave originating from the target object may be input to the full-color holographic image generation system through the objective lens and may be defined as a linear polarized state by the polarizer. Thereafter, modulation may be performed such that half of the polarized light has positive curvature and the other half has negative curvature, by passing through the diffractive lens. Thereafter, when passing through the polarizers having different phase values (for example, the polarizers rotating by 0, 45, 90 and 135 degrees and having a 2×2 configuration), which are attached to each pixel of the polarization image sensor), brightness information according to interference may be recorded on a sensor surface. The brightness information according to interference may be used to acquire the original image or may be included in the original image.

Thereafter, an interference fringe for each polarization or color may be extracted from the original image (e.g., a raw, bmp or png image). That is, the interference fringe may be recorded for each pixel by the color polarization image sensor including polarizers having different phase values. In this case, the interference fringe may be recorded as Fresnel fringe based on Fresnel diffraction. Complex hologram data may be generated by removing information on a light source and twin image information for each color channel (e.g., R, G and B) based on the interference fringe.

Thereafter, for example, by using an angular spectrum method or a Fresnel diffraction method, images for each color channel may be formed at optimal reconstruction points for each color. As an embodiment, the optimal reconstruction points for each color may be derived based on the imaging distance and the center wavelength of another channel, which may be the same as Equation 4 above.

After the images are formed at the optimal reconstruction points for each color channel, the formed images may be combined into one color image (S1002). When the images are formed for each color channel and are combined into one color image, it is possible to acquire a full-color image without the chromatic aberration effect.

Meanwhile, since the full-color holographic image generation method of FIG. 10 corresponds to an embodiment of the present disclosure, other steps may be added or the order of steps may be changed and the present disclosure is not limited to FIG. 10.

FIG. 11 is a view illustrating a full-color holographic image generation apparatus according to an embodiment of the present disclosure.

As an embodiment, the full-color holographic image generation apparatus of FIG. 11 may be included in the full-color holographic image generation system of FIG. 8 or 9, and may perform the full-color holographic image generation method of FIG. 10. Accordingly, the above description is applicable to the full-color holographic image generation apparatus of FIG. 11, unless it is contrary to the description of FIG. 11.

In addition, the full-color holographic image generation apparatus 1101 shown in FIG. 11 may include a transceiver 1102 for transmitting and receiving a signal and a processor 1103 for controlling the transceiver. Meanwhile, since FIG. 11 corresponds to an embodiment of the present disclosure, the transceiver and the processor may be configured in hardware and/or software having a different name. For example, the functions performed by the processor may be implemented by one or more components such as an imaging unit and/or an image combiner.

As an embodiment, the transceiver 1102 for transmitting and receiving the signal may receive a signal related to rays propagating from a target object or transmit and receive all signals necessary to form images for each color channel and to combine the images into one color image in the processor 1103. For example, complex hologram data or an interference fringe and an original image necessary to derive the interference fringe may be received. In addition, a signal derived by the processor 1103 may be transmitted. For example, the image formed for each color channel or one combined color image may be transmitted.

As an embodiment, the processor 1103 for controlling the transceiver may form the images for each color channel based on the complex hologram data extracted from the rays propagating from the target object in the full-color holographic image generation system or apparatus. Meanwhile, the images may be formed at the optimal reconstruction points for each color channel derived based on the complex hologram data. In addition, after the images are formed at the optimal reconstruction points for each color channel, the formed images may be combined into one color image. As an embodiment, the complex hologram data may be generated based on the interference fringe for each polarization or color channel extracted from the original image obtained by photographing the target object, and may be derived by removing the information on a light source and twin image information for each color channel based on the interference fringe. In addition, the interference fringe may be recorded by the color polarization image sensor including polarizers having different phase values for each pixel. In addition, the rays may be modulated to have one linear polarized state, and may be modulated such that some rays have positive curvature and some rays have negative curvature by the diffractive lens. In addition, the optimal reconstruction points for each color channel may be derived based on the imaging distance and the center wavelength of another color channel. The description of the other drawings is applicable to the process of forming the images for each color channel and combining the images into one color image by the processor 1103.

Meanwhile, the full-color holographic image generation apparatus may further include a color polarization image sensor or a diffractive lens, and the present disclosure is not limited to the embodiment of FIG. 11.

The various forms of the present disclosure are not an exhaustive list of all possible combinations and are intended to describe representative aspects of the present disclosure, and the matters described in the various forms may be applied independently or in combination of two or more.

For example, according to an embodiment of the present disclosure, a computer program stored in a medium for generating full-color holographic image may be implemented by computer-executable code to form images for each color channel based on complex hologram data extracted from rays propagating from a target object; and to combine the formed images into one color image, wherein the images for each color channel are formed at reconstruction points for each color channel derived based on the complex hologram data.

In addition, a computer that implements the computer program stored in the medium for generating full-color holographic image may include a mobile information terminal, a smart phone, a mobile electronic device, and a stationary type computer, to which the present disclosure is not limited.

In addition, various forms of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays A general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various embodiments to be performed on a device or computer, and a non-transitory computer-readable medium in which such software or instructions are stored and are executable on a device or computer. It will be apparent to those skilled in the art that various substitutions, modifications and changes are possible are possible without departing from the technical features of the present disclosure. It is therefore to be understood that the scope of the present disclosure is not limited to the above-described embodiments and the accompanying drawings.

What is claimed is:

1. A method of generating a full-color holographic image, the method comprising:
forming images for each color channel based on complex hologram data extracted from rays propagating from a target object; and
combining the formed images into one color image,
wherein the images for each color channel are formed at reconstruction points for each color channel derived based on the complex hologram data.

2. The method of claim 1, wherein the complex hologram data is generated based on an interference fringe for each polarization and color channel extracted from an original image obtained by photographing the target object.

3. The method of claim 2, wherein the complex hologram data is derived by removing information on a light source and twin image information for each color channel based on the interference fringe.

4. The method of claim 2, wherein the interference fringe is recorded as a Fresnel fringe based on a Fresnel diffraction method.

5. The method of claim 2, wherein the interference fringe is recorded by a color polarization image sensor including polarizers having different phase values for each pixel.

6. The method of claim 2, wherein the original image is one of a raw, bmp or png image.

7. The method of claim 2, wherein the images for each color channel are formed based on a Fresnel diffraction method using the interference fringe.

8. The method of claim 2, wherein the images for each color channel are formed based on an angular spectrum method using the interference fringe.

9. The method of claim 1, wherein the reconstruction points for each channel are derived based on an imaging distance and a center wavelength of another color channel.

10. The method of claim 1, wherein the rays are modulated to have one linear polarized state.

11. The method of claim 10, wherein the rays having one linear polarized state are modulated such that some rays have positive curvature and some rays have negative curvature by a diffractive lens.

12. The method of claim 11, wherein the diffractive lens is one of a meta lens or a geometric phase lens.

13. An apparatus for generating a full-color holographic image, the apparatus comprising:
a transceiver configured to transmit and receive a signal; and
a processor configured to control the transceiver,
wherein the processor forms images for each color channel based on complex hologram data extracted from rays propagating from a target object and combines the formed images into one color image, and
wherein the images for each color channel are formed at reconstruction points for each color channel derived based on the complex hologram data.

14. The apparatus of claim 13, wherein the complex hologram data is generated based on an interference fringe for each polarization and color channel extracted from an original image obtained by photographing the target object.

15. The apparatus of claim 14, wherein the complex hologram data is derived by removing information on a light source and twin image information for each color channel based on the interference fringe.

16. The apparatus of claim 14, wherein the interference fringe is recorded by a color polarization image sensor including polarizers having different phase values for each pixel.

17. The apparatus of claim 13, wherein the rays are modulated to have one linear polarized state and are modulated such that some rays have positive curvature and some rays have negative curvature by a diffractive lens.

18. The apparatus of claim 13, wherein the reconstruction points for each channel are derived based on an imaging distance and a center wavelength of another color channel.

19. A system for generating a full-color holographic image, the system comprising;
polarizers configured to define rays propagating from a target object in a linear polarized state;
a diffractive lens configured to modulate the rays defined in the linear polarized state from the polarizer to have positive or negative curvature;
a color polarization image sensor configured to record an interference fringe through the polarizers rotated to have different phases based on the modulated rays; and
a full-color holographic image generation apparatus configured to generate a full-color hologram by combining images for each color channel formed based on complex hologram data acquired based on the interference fringe.

20. The system of claim 19, wherein the diffractive lens is disposed on a front surface of the color polarization image sensor.
